(19) United States
(12) Patent Application Publication
(10) Pub. No.: US 2014/0092101 A1
(43) Pub. Date: Apr. 3, 2014

(54) APPARATUS AND METHOD FOR PRODUCING ANIMATED EMOTICON

(71) Applicant: Samsung Electronics Co., Ltd., Gyeonggi-do (KR)

(72) Inventors: Dong-Hyuk LEE, Seoul (KR); Do-Hyeon Kim, Suwon-si (KR); Jung-Rim Kim, Gyeonggi-do (KR); Seong-Taek Hwang, Gyeonggi-do (KR)

(73) Assignee: Samsung Electronics Co., Ltd., Gyeonggi-do (KR)

(21) Appl. No.: 14/031,515

(22) Filed: Sep. 19, 2013

(30) Foreign Application Priority Data
Sep. 28, 2012 (KR) 10-2012-0109181

(51) Int. Cl. G06T 13/80

(52) U.S. Cl. CPC G06T 13/80
USPC 345/473

(57) ABSTRACT

An apparatus and method for producing an animated emoticon are provided. The method includes producing a plurality of frames that constitute the animated emoticon; inputting at least one object for each of the plurality of frames; producing object information for the input object; and producing structured animated emoticon data that include each of the plurality frames and the object information.

### PRIORITY

This application claims priority under 35 U.S.C. §119(a) to Korean Application Serial No. 10-2012-0109181, which was filed in the Korean Intellectual Property Office on Sep. 28, 2012, the entire content of which is hereby incorporated by reference.

### BACKGROUND OF THE INVENTION

1. Field of the Invention

The present invention relates generally to an apparatus and method for producing an animated emoticon, and more particularly, to a computer, a smart phone, an apparatus including a touch screen and a mobile communication device that produces an animated emoticon, and a method of controlling the same.

2. Description of the Related Art

Recently, smart phones and tablet PCs. A smart phone or a tablet PC may execute an application that allows text, photographs or moving images to be transmitted/received between subscribers. Thus, a subscriber may create a desired text or transmit a photograph or a moving image to another subscriber. Further, a related application may provide an animated emoticon configured by a small number of frames. The animated emoticon may be created to efficiently express the user's emotional status, feeling, or the like. The subscriber may buy a desired animated emoticon from an application provider and may transmit the purchased animated emoticon to another subscriber.

However, ordinary subscribers cannot gain access to professional technologies for producing animated emoticons by themselves. Thus, subscribers may not produce a desired animated emoticon. In addition, a UI (User Interface) that allows an ordinary subscriber to easily modify an animated emoticon as desired so as to create a modified animated emoticon has not been available to the public.

Further, a UI that allows a user to modify a previously created animated emoticon as desired and to create a new animated emoticon has not been available to the public. Thus, there is a need for a technology for a method of allowing a user to easily create a desired animated emoticon or to easily modify an animated emoticon.

### SUMMARY OF THE INVENTION

Accordingly, the present invention has been made to address the above-described disadvantages and problems, and to provide the advantages described below. Accordingly, an aspect of the present invention is to provide an apparatus and a method that allow a user to easily create a desired animated emoticon, and further, to easily modify an animated emoticon.

According to an aspect of the present invention, there is provided a method of producing an animated emoticon. The method includes producing a plurality of frames that constitute the animated emoticon; inputting at least one object for each of the plurality of frames; producing object information for the input object; and producing structured animated emoticon data that include each of the plurality frames and the object information.

According to another aspect of the present invention, there is provided an apparatus of producing an animated emoticon. The apparatus includes an input unit configured to input a plurality of frames that constitute the animated emoticon and at least one object for each of the plurality of frames; and a control unit configured to produce object information for the input object and produce structured emoticon data including each of the plurality of claims and the object information.

According to various embodiments of the present invention, there are provided an apparatus and a method that allow a user to easily create a desired animated emoticon and also to easily modify the animated emoticon. Especially, there are provided an apparatus and a method in which information for a creating sequence of a previously created animated emoticon is stored so that each of the frames of the animated emoticon may be easily modified at a later time.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a schematic block diagram illustrating a mobile apparatus according to an embodiment of the present invention;

FIG. 2 is a perspective view illustrating a mobile apparatus according to an embodiment of the present invention;

FIG. 3 is a flowchart describing an animated emoticon producing method according to an embodiment of the present invention;

FIGS. 4A to 4C are conceptual views of UIs according to the present invention;

FIGS. 5 and 6 are structural views for describing data structures for an animated emoticon according to an embodiment of the present invention; and

FIGS. 7A and 7B are conceptual views for describing an animated emoticon producing method according to another embodiment of the present invention.

### DETAILED DESCRIPTION OF EMBODIMENTS OF THE PRESENT INVENTION

Hereinafter, embodiments of the present invention will be described with reference to the accompanying drawings. However, the present invention is not restricted or limited by the described embodiments. The same reference numerals represented in each of the drawings indicate the elements that perform substantially the same functions.

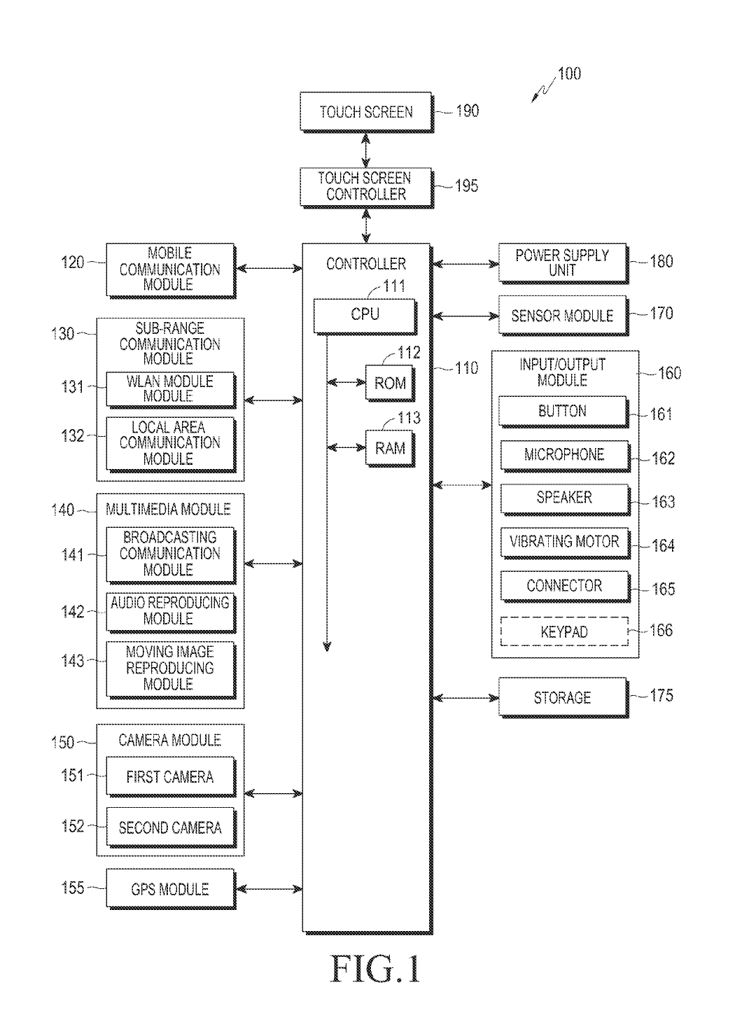

FIG. 1 is a schematic block diagram illustrating a mobile apparatus according to an embodiment of the present invention.

Referring to FIG. 1, the mobile apparatus 100 may be connected with an external apparatus (not illustrated) using an external apparatus connection unit such as a mobile communication module 120, a sub-communication module 130, and a connector 165. The “external apparatus” may include another apparatus (not illustrated), a portable phone (not illustrated), a smart phone (not illustrated), a tablet PC (not illustrated), and a server (not illustrated).

Referring to FIG. 1, the mobile apparatus 100 includes a display unit 190 and a display controller 195. Display unit 190 may include a touch screen, while display controller would be a touch screen controller. In addition, the mobile apparatus 100 may include a controller 110, a mobile communication module 120, a sub-communication module 130, a multimedia module 140, a camera module 150, a GPS module 155, an input/output module 160, a sensor module 170, a storage unit 175, and a power supply unit 180. The sub-communication module 130 includes at least one of a wireless LAN module 131 and a local area communication module 132, and the multimedia module 140 includes at least one of a broadcasting communication module 141, an audio reproducing module 142, and a moving image reproducing module 143. The camera module 150 includes at least one of a first camera 151 and a second camera 152, and the input/output module 160 includes at least one of a button 161, a microphone 162, a speaker 163, a vibration motor 164, a connector 165, and a keypad 166.

The controller 110 may include a CPU 111, a ROM 112 in which control programs for controlling the mobile apparatus 100 are stored, and a RAM 113 which stores signals or data input from outside of the mobile apparatus 100, or is used as a memory region for an operation executed in the mobile apparatus 100. The CPU 111 may include a single core, dual cores, triple cores, or quad cores. The CPU 111, the ROM 112 and the RAM 113 may be connected with each other through internal buses.

The controller 110 controls the mobile communication module 120, the sub-communication module 130, the multimedia module 140, the camera module 150, the GPS module 155, the input/output module 160, the sensor module 170, the storage unit 175, the power supply unit 180, the touch screen 190, and the touch screen controller 195.

The mobile communication module 120 allows the mobile apparatus 100 to be connected with an external apparatus through mobile communication using one or more antennas (not illustrated) according to the control of the controller 110.

The connector 165 may be used as an interface which interconnects the mobile apparatus 100 and an external apparatus (not illustrated) or a power source (not illustrated). The mobile apparatus 100 may transmit data stored in the storage unit 175 of the mobile apparatus 100 to the external apparatus (not illustrated) or receive data from an external apparatus (not illustrated) through a wired cable connected to the connector 165 according to the control of the control unit 110. The mobile apparatus 100 may receive power from the power source (not illustrated) through the wired cable connected to the connector 165 or charge a battery (not illustrated using the power source).

The storage unit 175 stores signals or data input/output in response to the operations of the mobile communication module 120, the sub-communication module 130, the multimedia module 140, the camera module 150, the GPS module 155, the input/output module 160, the sensor module 170, and the touch screen 190 according to the control of the control unit 110. The storage unit 175 stores control programs and applications for controlling the mobile apparatus 100 or the control unit 110.

The term, “storage unit” may include the storage unit 175, the ROM 112 and the RAM 113 in the control unit 110, or a memory card (e.g., an SD card or a memory stick) mounted in the mobile apparatus 100. The storage unit may include a non-volatile memory, a volatile memory, an HDD (Hard Disc Drive) or an SSD (Solid State Drive).

The touch screen 190 provides a plurality of user interfaces that correspond to various services (e.g., phone call, data transmission, broadcasting and photographing), respectively, to the user. The touch screen 190 transmits an analogue signal corresponding to at least one touch input to the user interfaces to the touch screen controller 195. The touch screen 190 receives an input through the user's body (e.g., fingers including a thumb) or a touchable input device (e.g., a stylus pen). In addition, the touch screen 190 receives an input of continuous movement of a touch among one or more touches. The touch screen 190 transmits an analogue signal corresponding to the continuous movement of the touch input thereto to the touch screen controller 195.

In the present invention, the touch is not limited to a contact between the touch screen 190 and the user's body or a touchable input device and includes a contactless touch (e.g., the detectable space between the touch screen 190 and the user's body or a touchable input device is not more than 1 mm) The space detectable from the touch screen 190 may be changed according to the performance or configuration of the mobile apparatus 100.

The touch screen 190 may be implemented, for example, in a resistive type, a capacitive type, an infrared type, or an acoustic wave type.

The touch screen controller 195 converts an analogue signal received from the touch screen 190 into a digital signal (e.g., an X and Y coordinate) and transmits the digital signal to the controller 110. The controller 110 controls the touch screen 190 using the digital signal received from the touch screen controller 195. In addition, the touch screen controller 195 may be included in the control unit 110.

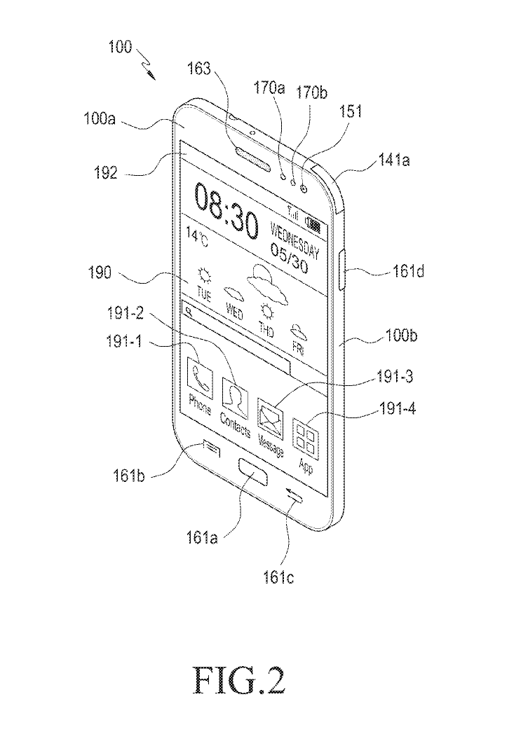

FIG. 2 is a perspective view of a mobile apparatus according to an embodiment of the present invention.

Referring to FIG. 2, a touch screen 190 is arranged at the center of the front surface 100a of the mobile apparatus 100. The touch screen 190 is formed in a large size so that the touch screen 190 occupies almost all the front surface 100a of the mobile apparatus 100. A first camera 151 and an illumination sensor 170a may be arranged at an edge of the front surface 100a of the mobile apparatus 100. On a side surface 100b of the mobile apparatus 100, for example, a power/reset button 161a, a volume button 161b, a speaker 163, a terrestrial DMB antenna 141a that receives broadcasting, and one or more microphones (not illustrated), and a connector (not illustrated) may be arranged, and on the rear surface (not illustrated) of the mobile apparatus 100, a second camera may be arranged.

When any of the execution keys 191-1, 191-2, 191-3 and 191-4 is touched, the application corresponding to the touched execution key 191-1, 191-2, 191-3 and 191-4 is executed and displayed on the touch screen 190.

For example, when the home screen moving button 161 a is touched while the applications are being executed on the touch screen 190, the home screen is displayed. A back button 161c causes the screen executed just prior to the currently executed screen to be displayed or the most recently used application to be ended.

In addition, at the top end of the touch screen 190, a top end bar 192 may be formed that indicates the status of the mobile apparatus 100 such as the battery charge status, the intensity of a received signal and current time.

The applications are different from a composite-functional application in which one application (e.g., a moving image application) is additionally provided with some functions (a memo function, a message transmission/reception function) provided by any other application in that the applications are implemented independently from each other. However, such a composite-functional application is a single application newly created to have various functions and differentiated from existing applications. Accordingly, the composite-functional application may provide limited functions rather than providing various functions like existing applications. Further, the user separately buys such a new composite-functional application.

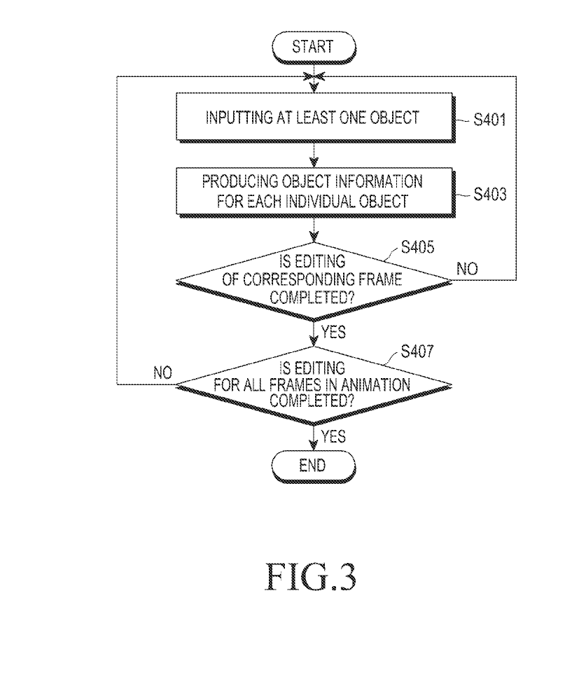

FIG. 3 is a flowchart describing an animated emoticon producing method according to an exemplary embodiment of the present invention. The emoticon producing method of FIG. 3 may be executed by the mobile apparatus 100 illustrated in FIG. 1.

The mobile apparatus 100 receives an input of at least one object from the user in step S401. Here, the object may be formed in various shapes, including, for example, a text, a figure, an icon, a button, a check box, a photograph, a moving image, a web, a map, etc. When the user touches the object, a function or a predetermined event in the object may be executed in a corresponding application. Object information is produced for each individual object in step S403. According to an operating system, the object may be referred to as a view.

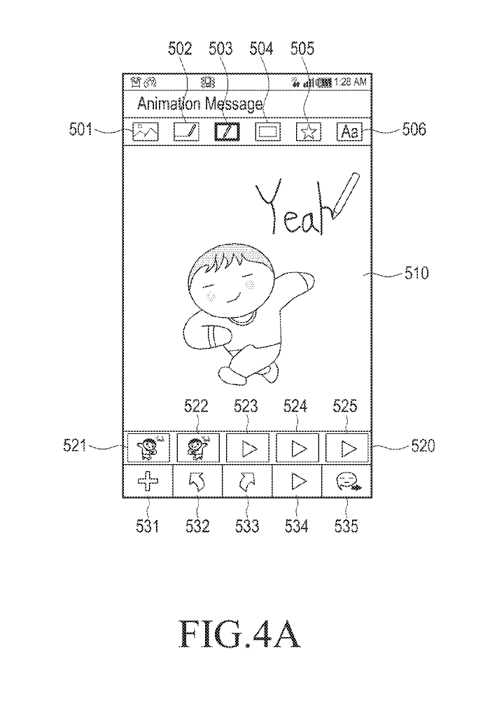

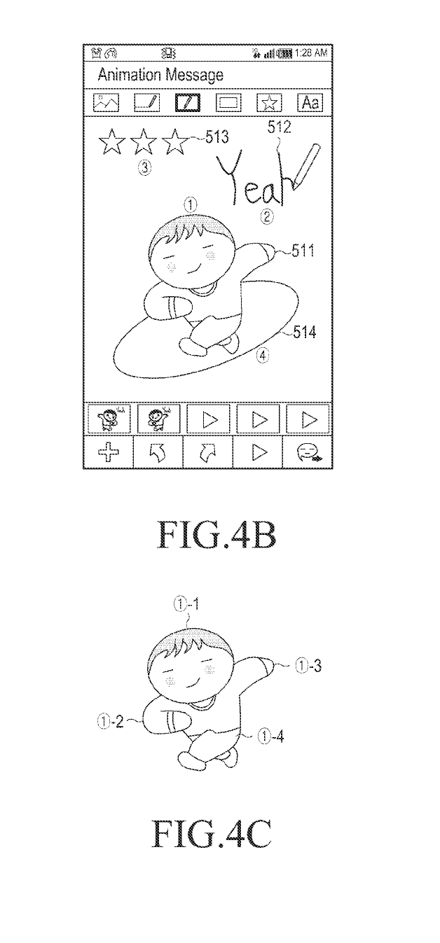

For example, the mobile apparatus 100 may provide an animated emoticon fabrication UI as in FIG. 4A.

An animated emoticon creation UI screen includes a photograph or moving image insert function key 501, a coloring function key 502, a line input function key 503, an animation interruption function key 504, a background music setting function key 505, and a character input function key 506.

The user may designate the photograph or moving image insert function key 501, and then inserts a desired photograph or moving image into a desired portion of an editing screen 510.

The user may designate the coloring function key 502, and then changes a desired portion of the editing screen 510 or the inside of a specific object to a specific color. For example, when the user designates the coloring function key 502, a color selection window may be displayed on which various colors may be additionally selected.

The user may designate the line input function key 503, and then inputs a line to a desired portion on the editing screen 510.

The user may designate the animation interruption function key 504, and the mobile apparatus 100 interrupts the execution of the animation. For example, the user may execute an animated emoticon created or edited by the user and designates the animation interruption function key 504 to interrupt execution of the animation.

The user may designate the background music setting function key 505 to control desired background music to be linked thereto.

The user may designate the character input function key 506 and then inputs a character to a desired portion of the editing screen 510.

Meanwhile, the editing screen 510 displays various objects of editing frames. The user may designate a desired portion of the editing screen 510 and operates various function keys as described above to insert or produce various objects at the desired portion on the editing screen 510. In the embodiment of FIG. 4B, a FIG. 511 in a dancing human shape is disposed at the central portion of the editing screen 510 and a line 512 expressed as “Yeah” is disposed at the right upper end portion of the editing screen 510.

Meanwhile, an animated emoticon creation UI screen further displays a frame information display portion 520 at the lower end of the editing screen 510. The frame information display portion 520 displays information of each of the frames that constitute an animated emoticon. For example, the frame information display portion 520 displays the number of frames that constitute the animated emoticon and displays an image thumb-nail for each of the frames. In the embodiment of FIG. 4A, it is displayed that the corresponding emoticon includes five frames, i.e., first to fifth frames 521 to 525 on the frame information display portion 520, and the image thumb-nail for each of the frames is displayed. Meanwhile, for the frames 523 to 525 which have not yet been created, marks indicating that they have not yet been created may be displayed.

Meanwhile, the animated emoticon creation UI screen may additionally display, at the lower end of the frame information display portion 520, a frame addition function key 531, an undo function key 532, a redo function key 533, an animation execution function key 534, and a back-to-chat window function key 535.

The user may designate the frame addition function key 531 and, in response to this, the mobile apparatus 100 adds a new frame that constitutes an animated emoticon.

The user may designate the undo function key 532 and, in response to this, the mobile apparatus 100 cancels the most recently executed input. For example, when the user adds a specific object and then designates the undo function key 532, the mobile apparatus 100 deletes the added specific object on the editing screen 510.

The user may designate the redo function key 533 and, in response to this, the mobile apparatus 100 again executes the input cancelled by the undo function key 532. For example, when the user has designated the undo function key 532 to cancel the input of the specific object, the user may input the redo function key 533 so that the specific object may be displayed on the editing screen 510 again.

The user may designate the animation execution function key 534 and, in response to this, the mobile apparatus 100 displays the produced or edited frames as the animation. For example, the mobile apparatus 100 may create an animation effect by displaying each of the frames for a predetermined length of time. Meanwhile, according to another embodiment, the mobile apparatus 100 may control an individual display time for each frame. For example, the mobile apparatus 100 may control an individual display time for each frame display. For example, the mobile apparatus 100 may set the display time of the first frame and the second frame to be twice that of the reproducing time of the third to fifth frames.

The user may designate the back-to-chat window function key 535 and, in response to this, the mobile apparatus 100 ends the animation editing. For example, the mobile apparatus 100 may end the animation editing and return the UI screen to the chat window.

FIG. 4B is an editing screen according to an embodiment of the present invention. As in step S401 in FIG. 3, the mobile apparatus 100 receives an input of at least one of objects 511 to 514 from the user.

The mobile apparatus 100 produces object information for each of the objects. The object information may include the type of an object, the producing sequence of the object, and one-body information of the object. For example, the mobile apparatus 100 may produce information that the \textcircled{1} object 511 is a figure, information that the producing sequence of the \textcircled{1} object 511 is first, and information that the object is a one-body. In addition, the mobile apparatus 100 may produce information that the \textcircled{2} object 512 is a line, information that the producing sequence of the \textcircled{2} object 512 is second, and information that the \textcircled{2} object 512 is a one-body. Meanwhile, the mobile apparatus 100 may produce the above-described object information for each of the \textcircled{3} object 513 and the \textcircled{4} object 514. Thus, even if the \textcircled{1} object 511 and the \textcircled{4} object 514 are displayed to be overlapped with each other, they may be differentiated as the \textcircled{1} object 511 is a one-body and the \textcircled{4} object 514 is another one-body.

More specifically, as in FIG. 4C, the mobile apparatus 100 may produce object information that the 511 object is also formed by first to fourth sub objects \textcircled{1}-1, \textcircled{1}-2, \textcircled{1}-3 and \textcircled{1}-4. For example, in order to draw the \textcircled{1} object 511, the user inputs the first sub object \textcircled{1}-1, and then sequentially inputs the second sub object \textcircled{1}-2 to the fourth sub subject \textcircled{1}-4. The mobile apparatus 100 may additionally store the producing sequence of the first sub object \textcircled{1}-1 to the fourth sub object \textcircled{1}-4 and whether they are a one-body or not.

Returning to FIG. 3, when the editing of corresponding frames is completed in step S405, the mobile apparatus 100 may repeat the above-described processes until the editing is completed for all the frames in the animation in step S407. If the editing is not completed in either of steps S405 or S407, the process returns to step S401.

Thus, a produced animated emoticon may include not only simple image information for frames but also information for a producing sequence of each object in the frames, the type of the object and whether the object is a one-body or not.

The user may easily create and edit an animated emoticon using the information for the producing sequence of objects and whether the objects are a one-body or not. For example, for the frame in which the \textcircled{1} object 511 and the \textcircled{4} object 514 are displayed to be overlapped with each other as in FIG. 4B, the mobile apparatus 100 may easily perform the creation and editing using the information for the producing sequence for the objects and whether the objects are a one-body or not. In order to modify the \textcircled{1} object 511, the user may designate the undo function key 532 so that the \textcircled{4} object 514 is not displayed. As described above, the \textcircled{4} object 514 is a one-body independent from the \textcircled{1} object 511 and has the fourth producing sequence. Thus, the user may designate the undo function key 532 once to erase the \textcircled{4} object 514 which is the one-body on the editing screen 510.

After erasing the \textcircled{4} object 514, the user of the mobile apparatus 100 may modify the \textcircled{1} object 511. When the modification of the \textcircled{1} object 511 is complete, the user designates the redo function key 533 to display the \textcircled{4} object 514 again. Thus, even if the \textcircled{1} object 511 and the \textcircled{4} object 514 are displayed to be overlapped with each other, the user may easily modify the frame. As described above, the conventional animated emoticon frame does not include information for the sequence of an object or whether the object is a one-body or not as in the present invention. Thus, in the prior art, there was a problem in that the user must modify a decided image itself in order to modify a frame. In particular, when the \textcircled{1} object 511 and the \textcircled{4} object 514 are overlapped with each other as in FIG. 4B, a problem arises in the prior art in that it is difficult for the user to modify the overlapping portion as well. In contrast, according to the present invention, the frame may be easily modified using the information for the producing sequence of the objects and whether each of the objects is a one-body or not.

Furthermore, the mobile apparatus 100 may adjust the display time of each frame and also modify its brightness or sepia. In addition, the mobile apparatus 100 may reproduce an animated emoticon together with voice data when the animated emoticon is executed through voice recording or background music setting.

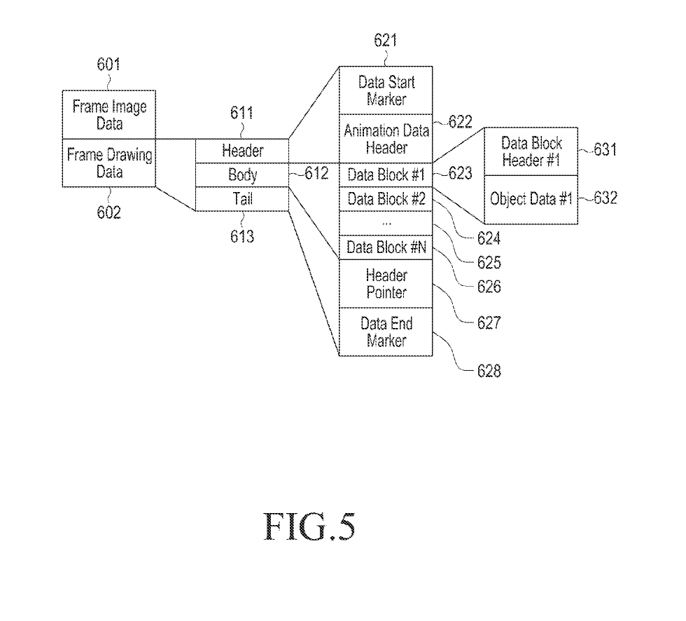

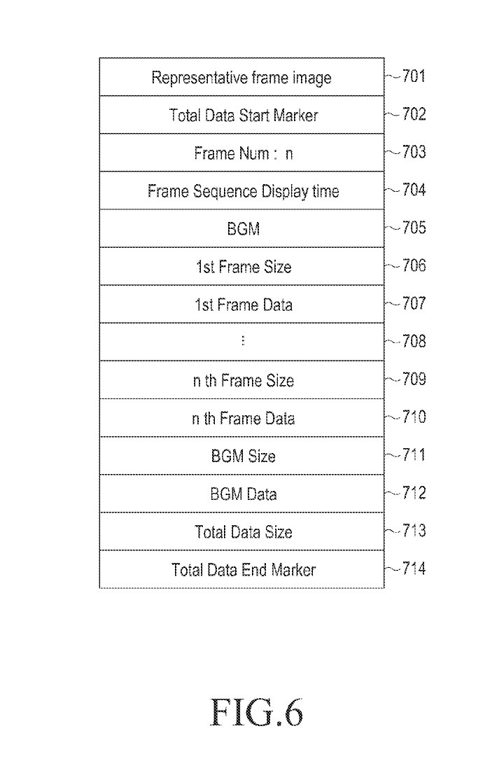

FIGS. 5 and 6 are structural views for describing data structures for an animated emoticon according to an embodiment of the present invention.

As illustrated in FIG. 5, data for an animated emoticon includes frame image data 601 and frame drawing data 602. Here, the frame image data 601 may be the data of a frame image itself and may be produced, for example, in an image format such as “png”. Meanwhile, the frame drawing data 602 may include object information for each of the above-described objects. The frame drawing data 602 may be disposed at the rear end of the frame image data. However, this is merely illustrative and no limit exists for the position of the frame image data.

The frame drawing data 602 may include a header 611, a body 612 and a tail 613 and each of the regions may be further subdivided.

First, the header 611 may include a data start marker 621 and an animation data header 622. The data start marker 621 indicates a start point of frame drawing data in an image and thus, may be a combination of a series of codes for search. The animation data header 622 may include header information such as an address of animation data. The header 611 of the frame drawing data may include various information for the entire frame drawing data structure and information required for decoding the entire frame drawing data for future re-editing, such as the number of data blocks included in the body.

Meanwhile, the body 612 may include object information. For example, the body 612 may include first to nₜₕ data blocks 623 to 626. Each data block may include a data block header 631 and object information 632. The data block header includes a property of an object within a corresponding frame image and metadata such as a data size stored in the corresponding object data region.

Meanwhile, the tail 613 may include a header pointer 627 and a data end marker 628.

FIG. 6 is a format of an animated emoticon structured according to an embodiment of the present invention. As illustrated in FIG. 6, the inventive format may include a representative frame image 701, an entire data start marker 702, frame number information 703, each frame's display time information 704, background sound information 705, first frame's size information 706, first frame information 707, plural frames-related information 708, nₜₕ frame's size information 709, nₜₕ frame's information 710, background sound size information 711, background sound data 712, entire data size information 713, and an entire data end marker 714.

The representative frame image 701 is one of a plurality of frames and may be designated as, for example, the first frame. The entire data start marker 702 may be a marker indicating that the entire data of a structured animated emoticon is started. The frame number information 703 may indicate the number of frames included in the animated emoticon. The each frame's display time information 704 may indicate information for a display time of each frame. The background sound information 705 may indicate information as to whether the sound is, for example, a recorded voice or a sound effect. The first frame's size information 706 may indicate information on the data size of the first frame. The first frame information 707 may include object information of individual objects included in the first frame. The plural frames-related information 708 includes information and object information for the remaining frames. The nₜₕ frame's size information 709 may indicate information for the data size for the nₜₕ frame. The nₜₕ frame's information 710 may include object information for individual objects included in the nₜₕ frame. The background sound size information 711 includes data size information of a background sound and the background sound data 712 includes the background sound data itself. The data size information 713 includes the size information of the entire structured data and the entire data end marker 714 indicates that the format of a structured animated emoticon is ended.

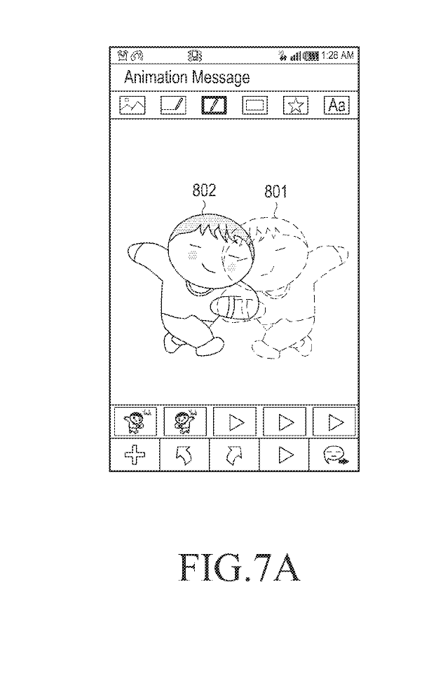

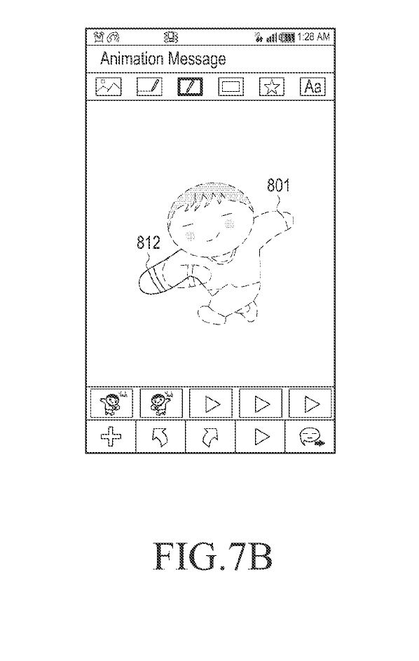

FIG. 7A is a conceptual view for describing an animated emoticon producing method according to another embodiment of the present invention. For example, the mobile apparatus 100 may provide a UI capable of producing a frame with reference to a previous frame. As illustrated in FIG. 7A, the mobile apparatus 100 provides a guide line 801 so as to refer to a first frame when producing a second frame. The user may input a new object 802 with reference to the guide line 801. Due to the nature of animation, higher similarity between frames may create more natural animation effects. Thus, the user may produce a more natural animated emoticon using the guide line 801 efficiently.

FIG. 7B is a conceptual view for describing an animated emoticon producing method according to another embodiment of the present invention. Also in FIG. 7B, the mobile apparatus 100 may provide a UI capable of producing a frame with reference to a previous frame. The user may input a new object 812 with reference to the guide line 801. In particular, the user may produce a new frame in the manner of re-using a part of the old object 801 and changing only a specific portion.

In addition, when the at least one object for each of the plurality of frames is input, an object with a lower priority may be erased when the undo function key is designated, and the most recently erased object may be produced again when the redo function key is designated.

It will be appreciated that the embodiments of the present invention may be implemented in a form of hardware, software, or a combination of hardware and software. Such arbitrary software may be stored, for example, in a volatile or non-volatile storage device such as an ROM, or, for example, a memory such as an RAM, a memory chip, a memory device or an integrated circuit, or a storage medium such as a CD, a DVD, a magnetic disc or a magnetic tape that may be optically or magnetically recorded and readable with a machine (for example, a computer) regardless of whether the software is erasable or rewritable or not. Also, it will be appreciated that the embodiments of the present invention may be implemented by a computer or a portable terminal which includes a control unit and a memory, in which the memory may be an example of a storage medium that is readable by a machine that is suitable for storing one or more programs that include instructions for implementing the embodiments of the present invention. Accordingly, the present invention includes a program that includes a code for implementing an apparatus or a method defined in any claim in the present specification and a machine (e.g., a computer) readable storage medium that stores such a program. Further, the program may be electronically transmitted through a medium such as a communication signal transferred through wired or wireless connection, and the present invention properly includes equivalents to the program.

In addition, the above-described electronic apparatus may receive and store the program from a program supply apparatus wiredly or wirelessly connected thereto. The program supply apparatus may include a program that includes instructions to execute the embodiments of the present invention, a memory that stores information or the like required for the embodiments of the present invention, a communication unit that conducts wired or wireless communication with the electronic apparatus, and a control unit that transmits a corresponding program to a transmission/reception apparatus in response to the request from the electronic apparatus or automatically.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A method of producing an animated emoticon, comprising:
producing a plurality of frames that constitute the animated emoticon;
inputting at least one object for each of the plurality of frames;
producing object information for the input object; and
producing structured animated emoticon data that include each of the plurality frames and the object information.

2. The method of claim 1, wherein the object information includes a type of the object, a producing sequence of the object, and one-body information of the object.

3. The method of claim 1, wherein the object includes at least one of a text, a figure, an icon, a button, a checkbox, a photograph, a moving image, a web, and a map.

4. The method of claim 1, wherein inputting at least one object for each of the plurality of frames includes:
providing a UI screen including at least one function key that allows the at least one object to be input; and
inputting the object based on the at least one function key.

5. The method of claim 4, wherein the at least one function key includes an undo function key that cancels the most recently executed input and a redo function key that re-executes the cancelled input.

6. The method of claim 5, wherein inputting at least one object for each of the plurality of frames erases an object with a lower priority when the undo function key is designated, and produces the most recently erased object again when the redo function key is designated.

7. The method of claim 1, wherein inputting at least one object for each of the plurality of frame includes:
providing a guide line for an object of a previous frame; and
producing a new frame by receiving an input of the object with reference to the guide line.

8. The method of claim 7, further comprising:
re-using the guide line as an object for the new frame.

9. The method of claim 1, wherein producing structured animated emoticon data further includes producing information for each display time that constitutes the animated emoticon.

10. The method of claim 1, wherein producing structured animated emoticon data further includes producing information for a background sound.

11. An apparatus of producing an animated emoticon, comprising:
an input unit configured to input a plurality of frames that constitute the animated emoticon and at least one object for each of the plurality of frames; and
a control unit configured to produce object information for the input object and produce structured emoticon data including each of the plurality of frames and the object information.

12. The apparatus of claim 11, the object information includes a type of the object, a producing sequence of the object, and one-body information of the object.

13. The apparatus of claim 11, wherein the object includes at least one of a text, a figure, an icon, a button, a checkbox, a photograph, a moving image, a web, and a map.

14. The apparatus of claim 11, further comprising:
a display unit configured to provide a UI screen including at least one function key that allows the at least one object to be input,
wherein the input unit receives an input of the object based on the at least one function key.

15. The apparatus of claim 14, wherein the at least one function key includes an undo function key that cancels the most recently executed input and a redo function key that re-executes the cancelled input.

16. The apparatus of claim 15, wherein the control unit is configured to erase an object with a lower priority when the undo function key is designated, and produces the most recently erased object again when the redo function key is designated.

17. The apparatus of claim 11, wherein the control unit is configured to provide a guide line for an object of a previous frame, and produces a new frame by receiving an input of the object with reference to the guide line.

18. The apparatus of claim 17, wherein the control unit is configured to re-use the guide line as an object for the new frame.

19. The apparatus of claim 11, wherein the control unit is configured to produce structured animated emoticon data further including information for each display time that constitutes the animated emoticon.

20. The apparatus of claim 11, wherein the control unit is configured to produce structured animated emoticon data further including information for a background sound.
